(19) United States
(12) Patent Application Publication
(10) Pub. No.: US 2001/0027466 A1
(43) Pub. Date: Oct. 4, 2001

(54) Electronic mail transfer device and system, electronic mail transfer method

(75) Inventor: Masahiko Honda, Tokyo (JP)

Correspondence Address: David A. Blumenthal, FOLEY & LARDNER, Washington Harbour, 3000 K Street, N.W., Suite 500, Washington, DC, 20007-5407, US

(73) Assignee: NEC CORPORATION

(21) Appl. No.: 09/812,816

(22) Filed: Mar. 21, 2001

(30) Foreign Application Priority Data
Mar. 22, 2000 (JP) 2000-080708

(51) Int. Cl. G06F 15/16

(52) U.S. Cl. 709/201

(57) ABSTRACT

An electronic mail transfer device which receives an electronic mail sent from a sending terminal through a communication line and sends the electronic received mail to a receiving terminal through the communication line according to an address of a destination party attached to the electronic mail, separates the electronic mail into text data and the other data when the received electronic mail includes the data other than the text data, and sends only the text data to the receiving terminal after relating the separated text data with the data other than the text data.

### BACKGROUNDS OF THE INVENTION

1. Field of the Invention

The present invention relates to an electronic mail transfer device and an electronic mail transfer system for sending a received electronic mail to a destination address attached on the electronic mail.

2. Description of the Related Art

In these days, an electronic mail is frequently used instead of communication means such as telephone and letters, with prevalence of a computer such as a personal computer (hereinafter, referred to “PC”) and Internet. Further, an electronic mail is prevailing, now in a situation capable of sending and receiving not only through a PC but also through a portable information terminal including a portable telephone.

This situation is due to downsizing and downcosting of a portable information terminal including a portable telephone with progress of LSI technology. Further, a portable telephone is in a position to send and receive an electronic mail including graphic data, with progress of compression technology of graphic data and application data.

In the case of sending and receiving an electronic mail through a portable telephone, however, there are the following problems. Since graphic data is generally large in data volume, it takes much time to send and receive an electronic mail including the graphic data. The data transfer speed between a portable telephone and a network is much lower than that of the general wired network such as NTT phone line.

Accordingly, it takes much more time to send and receive an electronic mail including graphic data through a portable telephone.

Since a portable telephone is distant from or far away from the reach of electronic waves, it is impossible to send and receive an electronic mail under stable communication environment constantly. In order to send and receive an electronic mail without fail, it is necessary to send and receive an electronic mail while the portable telephone it is standing under the stable communication environment and to do it in a short time.

Further, since the communication fee of a portable telephone is more expensive than that of the wired network, a user of a portable telephone is eager that an electronic mail can be sent and received in a short time.

Since it takes a lot of time to send and receive graphic data through a portable telephone, there is a system in which the graphic data can be compulsorily abandoned and only the text data can be referred to at the side of a portable telephone which receives an electronic mail including graphic data. In this case, the abandoned graphic data cannot be referred to later and the improvement is desired.

### SUMMARY OF THE INVENTION

An object of the present invention is to provide an electronic mail transfer device and an electronic mail transfer system capable of sending and receiving an electronic mail in a short time through a portable information terminal such as a portable telephone.

According to the first aspect of the invention, an electronic mail transfer device which receives an electronic mail sent from a sending terminal through a communication line and sends the received electronic mail to a receiving terminal through the communication line according to an address of a destination party attached to the electronic mail, comprises

a means for separating the electronic mail into text data and the other data when the received electronic mail includes the data other than the text data, and

a means for sending only the text data to the receiving terminal after relating the separated text data with the data other than the text data.

In the preferred construction, the electronic mail transfer device further comprises

a means for storing the separated data other than the text data with a discriminating symbol attached there, and

a means for inserting the discriminating symbol into the text data,

the text data with the discriminating symbol inserted therein being sent by the sending means to the receiving terminal through the communication line.

In another preferred construction, the data other than the text data related with the text data and stored in the storing means is sent to the receiving terminal or deleted, at a request of the receiving terminal.

In another preferred construction, the electronic mail transfer device further comprises

a means for assigning a temporary tag for the number of the separated data other than the text data, to the separated text data,

the inserting means replacing the tag with the corresponding discriminating symbol.

In another preferred construction, the communication line is the Internet.

In another preferred construction, the data other than the text data is an attached file.

In another preferred construction, the data other than the text data is graphic data or a computer executable program.

According to the second aspect of the invention, an electronic mail transfer system provided with an electronic mail transfer device of receiving an electronic mail sent from a sending terminal through a communication line and sending the received electronic mail to a receiving terminal through the communication line according to an address of a destination party attached to the electronic mail, a plurality of the sending terminals for sending the electronic mail to the electronic mail transfer device through the communication line, and a plurality of the receiving terminals for receiving the electronic mail sent from the electronic mail transfer device through the communication line, in which

the electronic mail transfer device comprises

a means for separating the electronic mail into text data and the other data when the received electronic mail includes the data other than the text data, and

a means for sending only the text data to the receiving terminal after relating the separated text data with the data other than the text data.

In the preferred construction, the electronic mail transfer device further comprises

a means for storing the separated data other than the text data with a discriminating symbol attached there, and

a means for inserting the discriminating symbol into the text data,

the text data with the discriminating symbol inserted therein being sent by the sending means to the receiving terminal through the communication line.

In another preferred construction, the electronic mail transfer device

sends the data other than the text data related with the text data and stored in the storing means to the receiving terminal or deletes the same data, at a request of the receiving terminal.

In another preferred construction, the electronic mail transfer device further comprises

a means for assigning a temporary tag for the number of the separated data other than the text data, to the separated text data,

the inserting means replacing the tag with the corresponding discriminating symbol.

In another preferred construction, the communication line is the Internet.

In another preferred construction, the data other than the text data is an attached file.

In another preferred construction, the data other than the text data is graphic data or a computer executable program.

According to another aspect of the invention, an electronic mail transfer method for receiving an electronic mail sent from a sending terminal through a communication line and sending the received electronic mail to a receiving terminal through the communication line according to an address of a destination party attached to the electronic mail, comprising

a step of separating the electronic mail into text data and the other data when the received electronic mail includes the data other than the text data, and

a step of sending only the text data to the receiving terminal after relating the separated text data with the data other than the text data.

In the preferred construction, the electronic mail transfer method further comprises a step of storing the separated data other than the text data with a discriminating symbol attached there, a step of inserting the discriminating symbol into the text data, and a step of sending the text data with the discriminating symbol inserted therein to the receiving terminal through the communication line.

In another preferred construction, the electronic mail transfer method further comprises a step of sending the data other than the text data related with the text data and stored in the storing means to the receiving terminal or deleting the same data, at a request of the receiving terminal.

In another preferred construction, the electronic mail transfer method further comprises a step of assigning a temporary tag for the number of the separated data other than the text data, to the text data, at a time of separation, and a step of replacing the tag with the corresponding discriminating symbol at a time of sending.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing the structure of an electronic mail transfer system according to an embodiment of the present invention;

FIG. 2 is a block diagram showing the internal structure of a receiving server of FIG. 1;

FIG. 3 is a block diagram showing the structure of an attached file server of FIG. 1;

FIG. 4 is a conceptual view of an electronic mail with URL attached;

FIG. 5 is a flow chart for use in describing the operation of an electronic mail transfer system of the embodiment.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

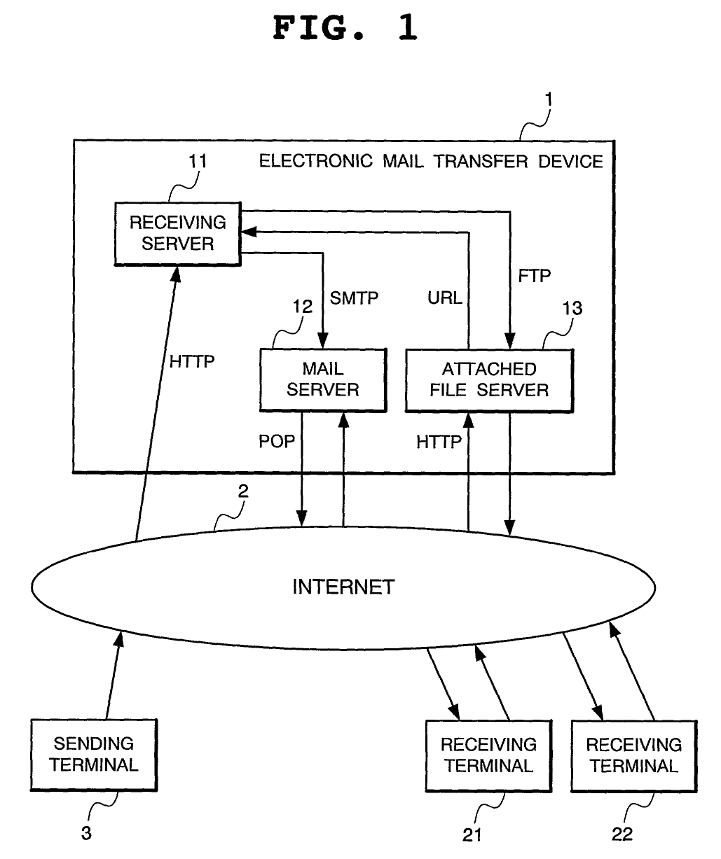

FIG. 1 shows the structure of an electronic mail transfer system according to the embodiment of the present invention. The electronic mail transfer system as shown in FIG. 1 comprises an electronic mail transfer device 1 for performing a transfer service of an electronic mail, Internet 2 that is a communication line connected to the electronic mail transfer device 1, a sending terminal 3 for sending an electronic mail to the electronic mail transfer device 1 through the Internet 2, and receiving terminals 21 and 22 for receiving the electronic mail sent from the sending terminal 3 through the Internet 2 and the electronic mail transfer device 1.

Although FIG. 1 shows only the sending terminal 3 and the receiving terminals 21 and 22 connected to the Internet 2, in fact, a plurality of sending terminals and a plurality of receiving terminals are connected there. Further, an access router (not illustrated) for connecting the Internet 2 is connected to the sending terminal 3 and the receiving terminals 21 and 22.

The electronic mail transfer device 1 includes a receiving server 11 that is a receiving means for receiving an electronic mail sent from the sending terminal 3 through the Internet 2, a mail server 12 that is a sending means for sending an electronic mail to a destination address through the communication line, and an attached file server 13 that is a storing means for storing attached files.

In this embodiment, although an electronic mail is separated into, for example, text data and attached file such as graphic data and computer executable program (application data) in the receiving server 11, another separating means for separating an electronic mail into an attached file and a text file may be provided, besides the receiving server 11.

Though the receiving server 11, the mail server 12, and the attached file server 13 shown in FIG. 1 can be mutually connected to each other through a LAN or the Internet 2, a mutual connection with each other through the LAN is preferable in order to prevent from leaking the content of the electronic mail to the other. Here, the description will be made in the case of the mutual connection via the LAN.

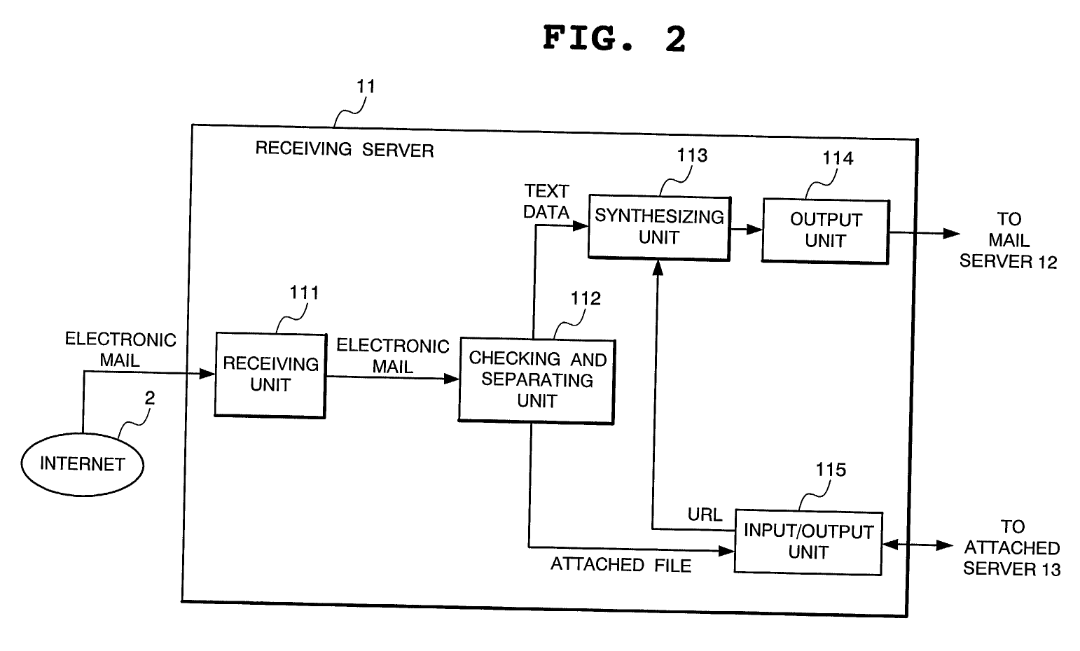

FIG. 2 is a view showing the internal structure of the receiving server 11. The receiving server 11 shown in FIG. 2 includes a receiving unit 111 for receiving an electronic mail being sent, a checking and separating unit 112 for checking whether an attached file is included in the electronic mail received by the receiving unit 111 and separating the mail into text data and the attached file if it is included, an input/output unit 115 for supplying an attached file to the attached file server 13 and receiving the URL (Uniform Resource Locator) put on the attached file in the attached file server 13, a synthesizing unit 113 for inserting the received URL into the text data, and an output unit 114 for sending the text data with the URL inserted therein to the mail server 12.

The checking and separating unit 112 inserts a temporary tag depending on the attached file, for example, a temporary tag indicating that it is the text data if the attached file is text data, when separating an attached file from an electronic mail. When an URL is inserted into text data, the temporary tag is to be used for discriminating it from the other URLs assigned by the attached file server 13 as described later, and the number of the temporary tags is coincident with the number of URLs.

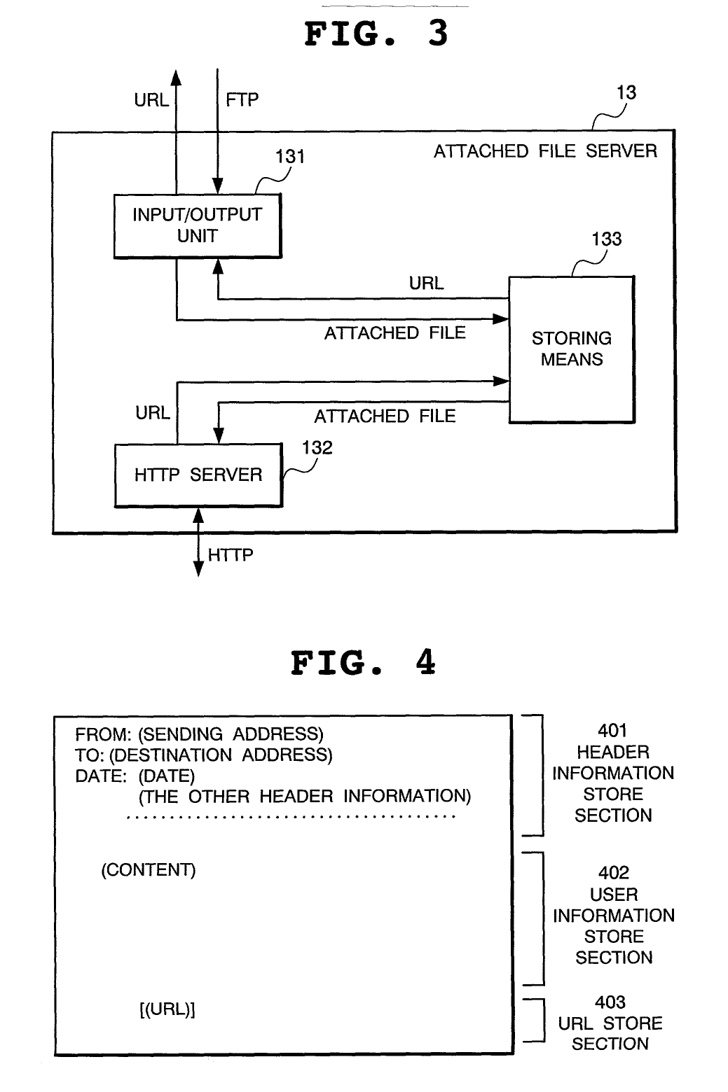

FIG. 3 shows the internal structure of the attached file server 13. The attached file server 13 shown in FIG. 3 includes an input/output means 131 for receiving an attached file supplied from the receiving server 11 and supplying the URL assigned to the attached file to the receiving server 11, a storing means 133 for storing the received attached file into a magnetic disk not illustrated and assigning an URL that is a discriminating symbol to the attached file, and an HTTP (Hyper Text Transfer Protocol) server 132 that is an extracting means for extracting the attached file from a magnetic disk based on the URL of the attached file sent from the receiving terminals 21 and 22.

When there are a plurality of attached files, each URL is assigned to the attached files, and a plurality of URLs are supplied to the side of the receiving server 11.

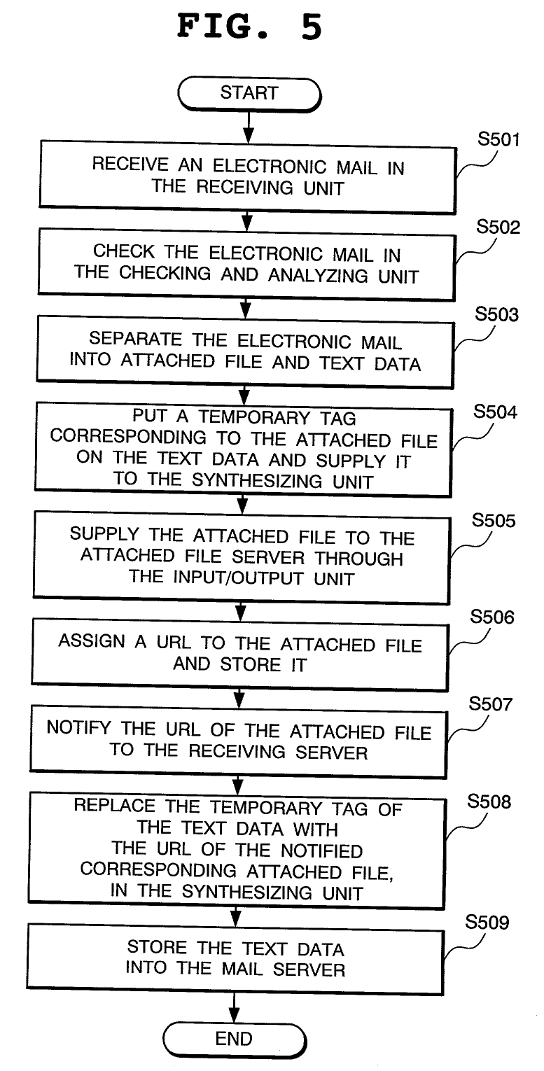

This time, the operation of the electronic mail transfer system of the embodiment will be described by using FIGS. 1 to 3 and the flow chart of FIG. 5. The description will be made assuming that the receiving terminals 21 and 22 belong to the same person, the receiving terminal 21 is a portable telephone, and that the receiving terminal 22 is a PC set on an office and the like.

When an electronic mail consisting of text data and an attached file is supplied from the sending terminal 3 to the receiving terminal 21, the electronic mail is received by the receiving unit 111 of the receiving server 11 of the electronic mail transfer device 1 through the Internet 2 (Step S501). The received electronic mail is supplied to the checking and separating unit 112. The checking and separating unit 112 checks whether the received electronic mail includes an attached file or not (Step S502).

Since the electronic mail includes an attached file, the received electronic mail is separated into an attached file and text data (Step S503). The text data is supplied to the synthesizing unit 113 after a temporary tag corresponding to the attached file is put on the text data (Step S504). The attached file is supplied to the input/output unit 115. The input/output unit 115 supplies the received attached file to the attached file server 13 (Step S505).

The attached file server 13 receives the supplied attached file from the input/output means 131 and supplies the same to the storing means 133. The storing means 133 assigns each URL to every received attached file and stores it into a magnetic disk not illustrated (Step S506). The storing means 133 supplies the URL for every attached file to the input/output means 131, thereby notifying the URL of each attached file to the receiving server 11 (Step S507).

The receiving server 11 receives the respective URLs supplied from the input/output means 131, through the input/output unit 115. The input/output unit 115 supplies the respectively received URLs to the synthesizing unit 113. The synthesizing unit 113 supplies the text data that has been previously received, with the respective URL inserted therein, to the synthesizing unit 113. More concretely, the respective temporary tags are replaced with the respectively corresponding URLs attached within the text data, and thereafter it is supplied to the output unit 114 (Step S508). The corresponding text data is stored into the mail server 12 from the output unit 114 (Step S509).

FIG. 4 is a conceptual view of an electronic mail supplied from the synthesizing unit 113 to the output unit 114. The electronic mail is provided with a header information store section 401 for storing the header information including a mail address of a sending party of the electronic mail, a mail address of a receiving party, and sending date of the electronic mail, a user information store section 402 for storing user information such as text data, and a URL store section 403 for storing a URL. Before the URL being stored, an attached file is provided there instead of the URL information.

When no attached file is included in an electronic mail, no temporary tag is put on the electronic mail in the checking and separating unit 112, and therefore, the electronic mail is supplied to the output unit 114 as it is without replacing a temporary tag with a URL in the synthesizing unit 113.

The output unit 114 supplies the electronic mail received from the synthesizing unit 113, to the mail server 12. At this time, data is transferred between the receiving server 11 and the mail server 12 by using a protocol, for example, SMTP (Simple Mail Transfer Protocol) or FTP (File Transfer Protocol).

The mail server 12 sends the received electronic mail to the receiving terminal 21 that is a portable telephone through the Internet 2. At this time, data is transferred between the mail server 12 and the receiving terminal 21 by using a protocol, for example, POP (Post Office Protocol). The receiving terminal 21 receives the text data and the URL and the text data is displayed on a display not illustrated.

Since the attached file is stored in the attached file server 13 as mentioned above, an owner of the receiving terminal 21 can receive an attached file stored in the attached file server 13 by using the receiving terminal 22, as mentioned later.

Based on the displayed text data, when an owner of the receiving terminal 21 wants to receive an attached file included in an electronic mail, through the receiving terminal 21, he or she can receive the attached file stored in the attached file server 13 by using the URL. More specifically, the receiving terminal 21 is arranged to display a menu screen upon selecting a URL. The menu is provided with “receive” and “delete”, and when a user of the receiving terminal 21 selects the “receive”, the receiving terminal 21 sends a command to the effect that the attached file should be sent, to the attached file server 13 through the Internet 2.

The attached file server 13 receives it through the HTTP server 132. With reference to the storing means 133 based on the received URL, it sends the attached file being stored to the receiving terminal 21 through the Internet 2.

On the other hand, when an owner of the receiving terminal 21 judges that the received attached file is not necessary, he or she selects “delete” to send a command to the effect that the attached file should be deleted, from the receiving terminal 21 to the attached file server 13, thereby deleting the attached file stored in the file server 13. When the attached file referred to is not deleted, the attached file is received by the receiving terminal 22 and it can be displayed on the display of the receiving terminal 22 as mentioned later.

Therefore, when an attached file is included in an electronic mail sent from the sending terminal 3 to the electronic mail transfer device 1, the text data within the electronic mail is sent to the receiving terminal 21 and thereafter, whether the attached file included in the electronic mail should be received or not depends on the necessity of an owner of the receiving terminal 21. Therefore, the receiving terminal 21 can receive an electronic mail in a short time.

When an attached file stored in the attached file server 13 is received by the receiving terminal 22, the URL is sent to the attached file server 13 through the Internet 2 and in the above same procedure, the stored attached file is sent from the attached file server 13 to the receiving terminal 22. Therefore, the owners of the receiving terminals 21 and 22 can afterward receive the graphic data corresponding to the already received text data.

In fact, since a plurality of sending terminals are connected to the Internet 2, it is supposed that there may happen the case of sending an electronic mail at the same time to the electronic mail transfer device 1. In this case, the processing such as separation can be performed on each electronic mail either in parallel or in sequential by the electronic mail transfer device 1.

As set forth hereinabove, when a received electronic mail includes text data and the other data, the present invention separates the electronic mail into the text data and the other data and stores the other data separated. Because of sending the separated text data, a receiving terminal can receive an electronic mail in a short time.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. An electronic mail transfer device which receives an electronic mail sent from a sending terminal through a communication line and sends the received electronic mail to a receiving terminal through the communication line according to an address of a destination party attached to the electronic mail, comprising:
a means for separating the electronic mail into text data and the other data when the received electronic mail includes the data other than the text data; and
a means for sending only the text data to the receiving terminal after relating the separated text data with the data other than the text data.

2. An electronic mail transfer device as set forth in claim 1, further comprising:
a means for storing the separated data other than the text data with a discriminating symbol attached there; and
a means for inserting the discriminating symbol into the text data,
the text data with the discriminating symbol inserted therein being sent by said sending means to the receiving terminal through the communication line.

3. An electronic mail transfer device as set forth in claim 2, wherein
the data other than the text data related with the text data and stored in said storing means is sent to the receiving terminal or deleted, at a request of the receiving terminal.

4. An electronic mail transfer device as set forth in claim 2, further comprising:
a means for assigning a temporary tag for the number of the separated data other than the text data, to the separated text data,
said inserting means replacing the tag with the corresponding discriminating symbol.

5. An electronic mail transfer device as set forth in claim 1, wherein
the communication line is the Internet.

6. An electronic mail transfer device as set forth in claim 1, wherein
the data other than the text data is an attached file.

7. An electronic mail transfer device as set forth in claim 1, wherein
the data other than the text data is graphic data or a computer executable program.

8. An electronic mail transfer system provided with an electronic mail transfer device of receiving an electronic mail sent from a sending terminal through a communication line and sending the received electronic mail to a receiving terminal through the communication line according to an address of a destination party attached to the electronic mail, a plurality of the sending terminals for sending the electronic mail to the electronic mail transfer device through the communication line, and a plurality of the receiving terminals for receiving the electronic mail sent from the electronic mail transfer device through the communication line, in which
the electronic mail transfer device comprises:
a means for separating the electronic mail into text data and the other data when the received electronic mail includes the data other than the text data; and
a means for sending only the text data to the receiving terminal after relating the separated text data with the data other than the text data.

9. An electronic mail transfer system as set forth in claim 8, wherein
the electronic mail transfer device further comprises:
a means for storing the separated data other than the text data with a discriminating symbol attached there; and
a means for inserting the discriminating symbol into the text data,
the text data with the discriminating symbol inserted therein being sent by said sending means to the receiving terminal through the communication line.

10. An electronic mail transfer system as set forth in claim 9, wherein
the electronic mail transfer device
sends the data other than the text data related with the text data and stored in said storing means to the receiving terminal or deletes the same data, at a request of the receiving terminal.

11. An electronic mail transfer system as set forth in claim 9, wherein
the electronic mail transfer device further comprises:
a means for assigning a temporary tag for the number of the separated data other than the text data, to the separated text data,
said inserting means replacing the tag with the corresponding discriminating symbol.

12. An electronic mail transfer system as set forth in claim 8, wherein
the communication line is the Internet.

13. An electronic mail transfer system as set forth in claim 8, wherein
the data other than the text data is an attached file.

14. An electronic mail transfer system as set forth in claim 8, wherein
the data other than the text data is graphic data or a computer executable program.

15. An electronic mail transfer method for receiving an electronic mail sent from a sending terminal through a communication line and sending the received electronic mail to a receiving terminal through the communication line according to an address of a destination party attached to the electronic mail, comprising the steps of:
a step of separating the electronic mail into text data and the other data when the received electronic mail includes the data other than the text data; and
a step of sending only the text data to the receiving terminal after relating the separated text data with the data other than the text data.

16. An electronic mail transfer method as set forth in claim 15, further comprising:
a step of storing the separated data other than the text data with a discriminating symbol attached there;
a step of inserting the discriminating symbol into the text data; and
a step of sending the text data with the discriminating symbol inserted therein to the receiving terminal through the communication line.

17. An electronic mail transfer method as set forth in claim 16, further comprising:
a step of sending the data other than the text data related with the text data and stored in said storing means to the receiving terminal or deleting the same data, at a request of the receiving terminal.

18. An electronic mail transfer method as set forth in claim 16, further comprising:
a step of assigning a temporary tag for the number of the separated data other than the text data, to the text data, at a time of separation; and
a step of replacing the tag with the corresponding discriminating symbol at a time of sending.
